(19) United States
(12) Patent Application Publication
(10) Pub. No.: US 2026/0198423 A1
(43) Pub. Date: Jul. 16, 2026

(54) EAR SAVER

(71) Applicant: Kenneth McGargill, Randolph, IA (US)

(72) Inventor: Kenneth McGargill, Randolph, IA (US)

(21) Appl. No.: 19/025,603

(22) Filed: Jan. 16, 2025

Related U.S. Application Data
(60) Provisional application No. 63/554,529, filed on Feb. 16, 2024.

(51) Int. Cl. A01D 45/02

(52) U.S. Cl. CPC A01D 45/023

(57) ABSTRACT

A crop-retaining device may include a brush comprising: a set of bristles; and a spine comprising: a front clamp plate disposed along a front side of the spine, a back clamp plate disposed along a back side of the spine, wherein the set of bristles are clamped between the front clamp plate and the back clamp plate, wherein the set of bristles extend from an inferior side of the spine, wherein the front clamp plate, the back clamp plate, and the set of bristles clamped between the front clamp plate and the back clamp plate comprise a first width; and a ridge disposed along a superior side of the spine comprising a second width greater than the first width, wherein at least one of the ridge and the front clamp plate are couplable to at least one coupler configured to couple the brush to a grain header.

### CROSS-REFERENCE TO RELATED APPLICATION

The present application claims the benefit under 35 U.S.C. § 119(e) of U.S. Provisional Application Serial Number 63/554,529, filed February 16, 2024, which is incorporated herein by reference in the entirety.

### BACKGROUND

Corn harvesting in the field is typically performed by a combine harvester, or combine, that combines the action of reaping, or harvesting, the ear of corn from the corn plant, and then threshing, or separating, the corn kernels from the ear. The harvesting of the ear of corn from the corn plant is performed via a corn header that removably attaches to the combine. The corn head includes gathering chains that transport loose ears of corn to an auger that feeds the ears to a feederhouse for threshing. Occasionally, the ears bounce off the auger, or other parts of the corn head (e.g., dividers, deflectors, and other corn header panel surfaces) where they may potentially be ejected from the corn head onto the ground. To decrease loss due to dropped ears, flaps made of flexible material (e.g., ear savers) are often placed at points close to the gathering chains (e.g., between the dividers) that prevent the ear from dropping out of the corn header. Currently, ear savers often cause a clogging up of the corn head with corn stalk material, particularly, when the corn head is operating in a lowered position in order to harvest corn from stalks that are close to the ground due to wind or other factors. The ear savers may also suffer from warpage from extended use, causing them to open (e.g., increase the space between the pair of ear savers) further over time, reducing their ability to prevent ears from dropping out of the corn header. Therefore, there is a need for an ear saver that does not suffer from the drawbacks of the traditional ear saver design.

### SUMMARY

In some embodiments, the techniques described herein relate to a crop-retaining device including: a brush including: a set of bristles; and a spine including: a front clamp plate disposed along a front side of the spine; a back clamp plate disposed along a back side of the spine, wherein the set of bristles are clamped between the front clamp plate and the back clamp plate, wherein the set of bristles extend from an inferior side of the spine, wherein the front clamp plate, the back clamp plate, and the set of bristles clamped between the front clamp plate and the back clamp plate include a first width; and a ridge disposed along a superior side of the spine, wherein the ridge includes a second width greater than the first width, wherein at least one of the ridge and the front clamp plate are couplable to at least one coupler configured to couple the brush to a grain header.

In some embodiments, the techniques described herein relate to a crop-retaining device, further including the at least one coupler.

In some embodiments, the techniques described herein relate to a crop-retaining device, wherein the at least one coupler includes: a bracket including: a top bracket plate including at least one aperture and configured to receive at least one fastener; a first support extending from a first side of the top bracket plate and configured to contact a grain header; and a second support extending from a second side of the top bracket plate and configured to contact the front clamp plate.

In some embodiments, the techniques described herein relate to a crop-retaining device, wherein an interior surface of the top bracket plate is configured to contact the ridge.

In some embodiments, the techniques described herein relate to a crop-retaining device, wherein an interior surface of the second support is configured to contact the ridge.

In some embodiments, the techniques described herein relate to a crop-retaining device, wherein an interior surface of the top bracket plate and an interior surface of the second support are configured to contact the ridge.

In some embodiments, the techniques described herein relate to a crop-retaining device, wherein the spine is configured to flex and retain a flexed position.

In some embodiments, the techniques described herein relate to a crop-retaining device, wherein the brush includes a strip brush.

In some embodiments, the techniques described herein relate to a crop-retaining device, wherein the brush includes a staple set brush.

In some embodiments, the techniques described herein relate to a grain header including: a pair of row dividers; each row divider pair of row dividers including a housing; a pair of gathering chains disposed adjacent to a respective pair of row dividers, each gathering chain of the pair of gathering chains including gathering fingers that extend into a gathering space between the pair of row dividers; and a pair of crop-retaining devices coupled to the respective pair of row dividers and disposed superior to the gathering chains, wherein each of the pair of crop-retaining devices include: a brush including: a set of bristles; and a spine including: a front clamp plate disposed along a front side of the spine; a back clamp plate disposed along a back side of the spine, wherein the set of bristles are clamped between the front clamp plate and the back clamp plate, wherein the set of bristles extend from an inferior side of the spine, wherein the front clamp plate, the back clamp plate, and the set of bristles clamped between the front clamp plate and the back clamp plate include a first width; and a ridge disposed along a superior side of the spine, wherein the ridge includes a second width greater than the first width, wherein at least one of the ridge and the front clamp plate are couplable to at least one coupler configured to couple the brush to the grain header.

In some embodiments, the techniques described herein relate to a grain header, further including the at least one coupler.

In some embodiments, the techniques described herein relate to a grain header, wherein the pair of crop-retaining devices form a selective barrier that allows a grain stalk to pass through in a first direction, but inhibits a separated grain or separated grain unit from passing through in a second direction.

In some embodiments, the techniques described herein relate to a grain header, wherein the pair of crop-retaining devices are each coupled to the housing of a respective row divider.

In some embodiments, the techniques described herein relate to a grain header, wherein the grain header includes a corn header, wherein each of the pair of row dividers include a fore portion couplable to one or more of the pair of the crop-retaining devices.

In some embodiments, the techniques described herein relate to a grain header, wherein the at least one coupler includes: a bracket including: a top bracket plate including at least one aperture and configured to receive at least one fastener; a first support extending from a first side of the top bracket plate and configured to contact at least one of a housing, a fore portion, or an aft portion of a row divider; and a second support extending from a second side of the top bracket plate and configured to contact the front clamp plate.

In some embodiments, the techniques described herein relate to a grain header, wherein an interior surface of the top bracket plate is configured to contact the ridge.

In some embodiments, the techniques described herein relate to a grain header, wherein an interior surface of the second support plate is configured to contact the ridge.

In some embodiments, the techniques described herein relate to a grain header, wherein an interior surface of the top bracket plate and an interior surface of the second support plate are configured to contact the ridge.

In some embodiments, the techniques described herein relate to a harvester including: a grain header including: a pair of row dividers; each row divider pair of row dividers including a housing; a pair of gathering chains disposed adjacent to the respective pair of row dividers, each gathering chain of the pair of gathering chains including gathering fingers that extend into a gathering space between the pair of row dividers; and a pair of crop-retaining devices coupled to a respective pair of row dividers and disposed superior to the gathering chains, wherein each of the pair of crop-retaining devices include: a brush including: a set of bristles; and a spine including: a front clamp plate disposed along a front side of the spine; a back clamp plate disposed along a back side of the spine, wherein the set of bristles are clamped between the front clamp plate and the back clamp plate, wherein the set of bristles extend from an inferior side of the spine, wherein the front clamp plate, the back clamp plate, and the set of bristles clamped between the front clamp plate and the back clamp plate include a first width; and a ridge disposed along a superior side of the spine, wherein the ridge includes a second width greater than the first width, wherein at least one of the ridge and the front clamp plate are couplable to at least one coupler configured to couple the brush to the grain header.

In some embodiments, the techniques described herein relate to a harvester, wherein the grain header includes a corn header.

### BRIEF DESCRIPTION OF THE DRAWINGS

The detailed description is described with reference to the accompanying figures. The use of the same reference numbers in different instances in the description and the figures may indicate similar or identical items. Various embodiments or examples ("examples") of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a partial perspective view of a grain header, in accordance with one or more embodiments of the disclosure.

FIG. 2 illustrates a side view of a crop-retaining device, in accordance with one or more embodiments of the disclosure.

FIG. 3A illustrates a close-up side view of the crop-retaining device, in accordance with one or more embodiments of the disclosure.

FIG. 3B illustrates a side view of the crop-retaining device, in accordance with one or more embodiments of the disclosure.

FIG. 4A illustrates an underside view of the coupler, in accordance with one or more embodiments of the disclosure.

FIG. 4B illustrates a side view of the coupler, in accordance with one or more embodiments of the disclosure.

FIG. 5 illustrates a close-up view of a crop-retaining device coupled to a fore portion 106a of the row divider, in accordance with one or more embodiments of the disclosure.

FIG. 6 illustrates a side view of a pair of crop-retaining devices arranged in a crop-retaining position, in accordance with one or more embodiments of the disclosure.

FIG. 7 illustrates a side view of a pair of crop-retaining devices arranged in a crop-retaining position, in accordance with one or more embodiments of the disclosure.

FIG. 8 illustrates a process flow diagram depicting a method for attaching the crop-retaining device to the row dividers, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Broadly, embodiments, of the inventive concepts disclosed herein are directed to a crop-retaining device that attaches to row dividers of a grain header and inhibits crop material from falling out of the grain header during harvest. The crop-retaining device includes a brush made of stiff and resilient bristles that are attached to a spine. The crop-retaining device also includes a coupler that attaches the crop-retaining device to a housing of the row divider. The crop-retaining device can be used for several types of grain headers, such as corn headers for the harvesting of corn.

Embodiments of the present disclosure are particularly advantageous for harvesting under conditions where crops have lain down close to the ground, such as the corn stalks that have lain down as the result of a windstorm or other adverse weather. When harvesting “down” stalks, corn headers have a tendency to plug up, particularly if solid “ear savers” are used. The bristle-based crop-retaining device of the present disclosure allows the down stalks to pass through the gathering space between the row dividers relatively unimpeded while still inhibiting or preventing ears of corn from falling out of the grain header.

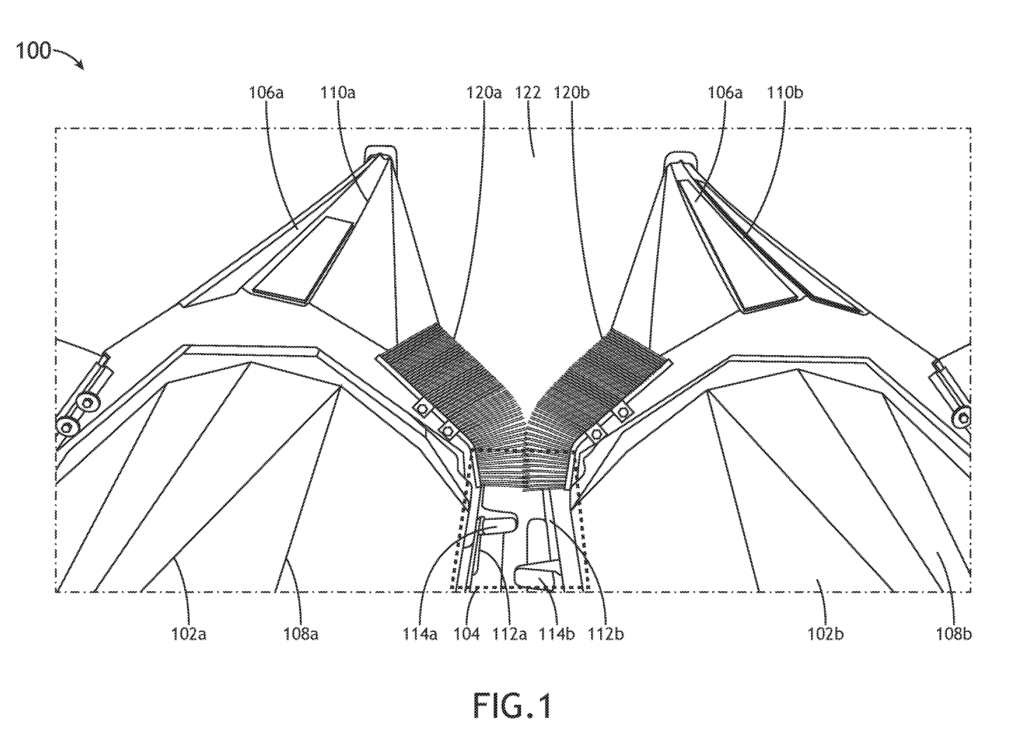

FIG. 1 illustrates a partial perspective view of a grain header 100, in accordance with one or more embodiments of the disclosure. The grain header 100 includes at least one pair of row dividers 102a, 102b that guide crops into a gathering space 104 between the pair of row dividers 102a, 102b as the grain header 100 proceeds forward.

The grain header 100 may include any type of threshing header that includes row dividers including, but not limited to, row-crop headers, corn headers, and chopper headers. Crops that can be harvested by the grain header 100 may include, but not be limited to corn, sorghum, sunflowers, soybeans, and millet. The grain header may be couplable to a harvester, such as a self-propelled harvester (e.g., a combine), or a vehicle-mounted harvester, such as a tractor-mounted harvester.

In embodiments, the row dividers 102a, 102b include a fore portion 106a, 106b (e.g., snouts), and an aft portion 108a, 108b. The fore portion 106a, 106b, and the aft portion 108a,108b may each include, or be formed as, a housing 110a, 110b.

In embodiments, the grain header 100 includes a pair of gathering chains 112a, 112b disposed adjacent to the respective pair of row dividers 102a, 102b. For example, the gathering chains 112a, 112b may each include gathering fingers 114a, 114b that function to gather in the crop as it enters into the gathering space 104 (e.g., the gathering fingers 114a, 114b extending into the gathering space 104).

In embodiments, the grain header 100 includes one or more crop-retaining devices 120a, 120b coupled to the pair of row dividers 102a, 102b. For example, the crop-retaining devices 120a, 120b may be coupled to the housing 110a, 110b, the fore portion 106a, 106b, and/or the aft portion 108a, 108b of the row dividers 102a, 102b. In this manner, a crop-retaining device 120a, 120b is disclosed, a grain header 100 that includes the crop-retaining device 120a, 120b is disclosed, and a harvester that includes the grain header 100 that that includes the crop-retaining device 120a, 120b is disclosed.

In embodiments, the crop-retaining devices 120a, 120b, are coupled to the row dividers 102a, 102b at a position superior to the gathering chains 112a, 112b (e.g., at or adjacent to the gathering space 104). When installed, the crop-retaining devices 120a, 120b form a selective barrier that allows grain stalks (e.g., such as corn stalks) and other plant components to pass through in a first direction through the gathering space and into the threshing apparatus of the harvester. The selective barrier also prevents or inhibits separated grain or grain units (e.g., corn ears) from passing through in a second direction (e.g., from the gathering space 104 and onto the ground 122).

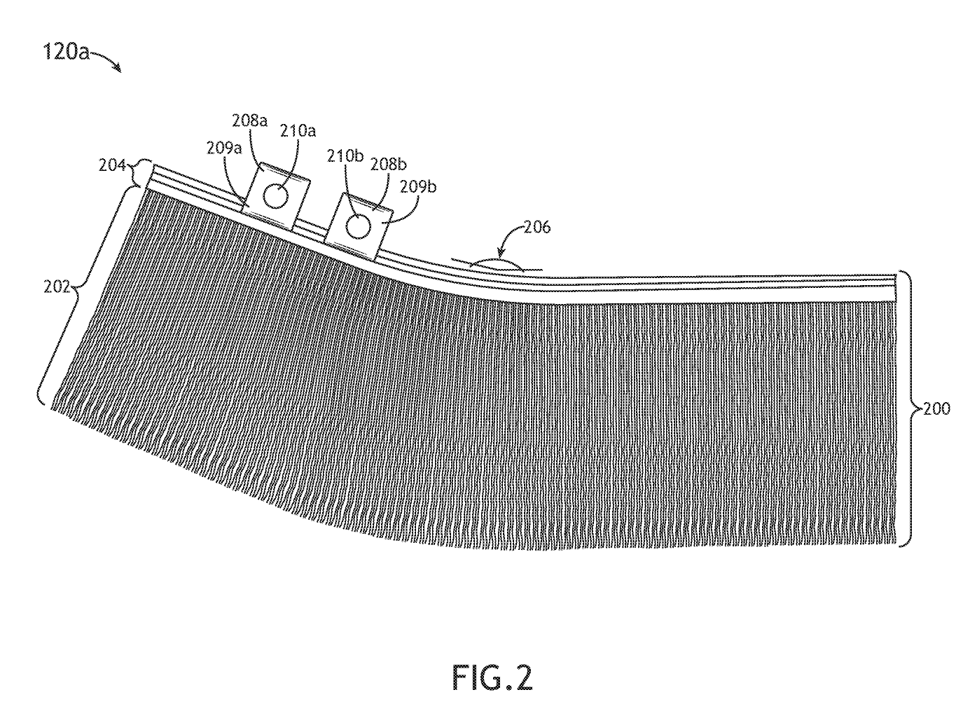

FIG. 2 illustrates a side view of a crop-retaining device 120a, in accordance with one or more embodiments of the disclosure. In embodiments, the crop-retaining devices 120a, 120b have a symmetry that allows a single crop-retaining device 120a to be used on either row divider 102a of the pair of row dividers 102a, 102b.

In embodiments, the crop-retaining device 120a includes a brush 200 containing a set of bristles 202 coupled to a spine 204. The set of bristles 202 may include any type of bristles 202 including, but not limited to organic or non-organic materials. For example, the set of bristles 202 may include organic or plastic-based bristles including, but not limited to, nylon bristles, polyester bristles, and polypropylene bristles. In another example, the set of bristles 202 may include metal bristles including, but not limited to wire bristles, steel bristles, and brass bristles. The brush 200 may include any type of brush form including but not limited to a strip brush or a staple brush.

In embodiments, the spine 204 includes any type of wear-resistant material including, but not limited to, metal and plastic. For example, the spine 204 may include aluminum and/or iron.

In embodiments, the spine 204 is flexible, and is configured to retain a flexed position. For example, the crop-retaining device 120a may originally be formed with a straight spine 204 that is then bent into a shape that most effectively forms the selective barrier when coupled to the grain header 100. For example, the spine 204 may be bent to form a slight angle 206. For instance, the grain header 100 may include two crop-retaining devices 120a, 120b that are both bent at slight angles and mounted onto the pair of row dividers 102a, 102b, forming a “Y” structure. In particular, the “Y” structure formed by the mounting of the two bent crop-retaining devices 120a, 120b row dividers 102a, 102b are able to form a selective barrier, preventing loss of ears of corn from the gathering space 104 as well as providing extra height to the fore portions 106a, 106b, preventing ears from bouncing over the fore portions 106a, 106b and onto the ground 122.

In embodiments, the crop-retaining device 120a includes one or more couplers 208a, 208b configured to couple the brush 200 to the row dividers 102a, 102b. For example, the one or more couplers 208a, 208b may include brackets that include top bracket plates 209a, 209b, and one or more apertures 210a, 210b for receiving one or more fasteners, such as a bolt or screw.

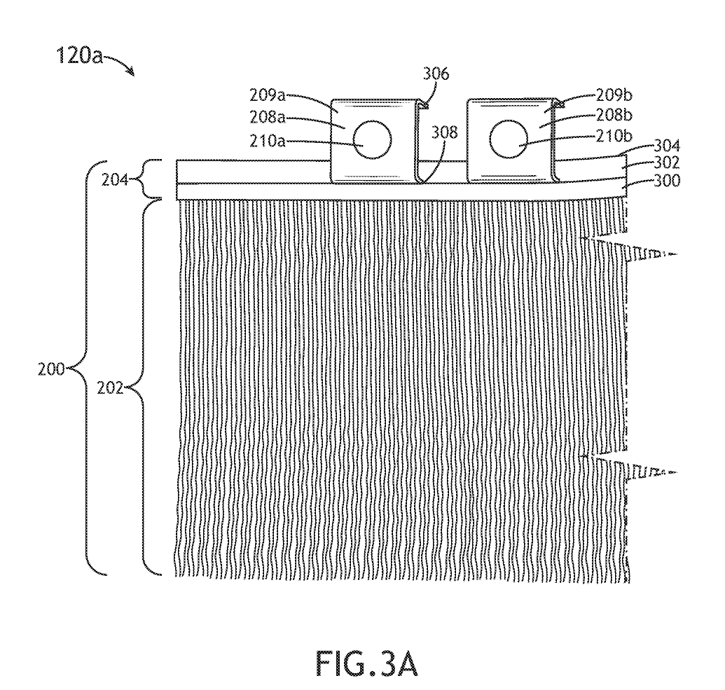

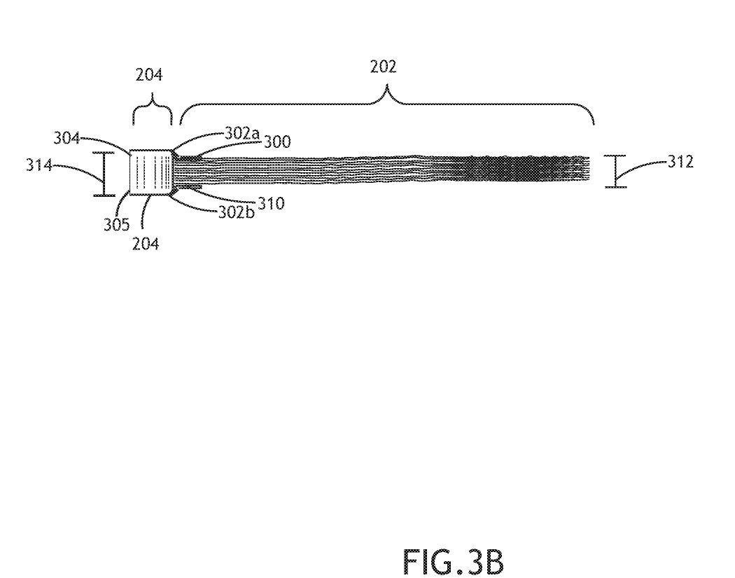

FIG. 3A illustrates a close-up side view of the crop-retaining device 120a, in accordance with one or more embodiments of the disclosure. In embodiments, the spine 204 includes a front clamp plate that is disposed along, or runs along, a length of the spine 204. The front clamp plate 300, along with a back clamp plate (e.g., not visible) provides a clamping force that secures the set of bristles 202 within the spine 204. Together, the front clamp plate 300, the back clamp plate, and the portion of the set of bristles 202 clamped within the front clamp plate 300 and the second clamp plate form a first width 312, as shown in FIG. 3B.

In embodiments, the spine 204 further includes a ridge 302 that is disposed along a superior side 304 of the spine 204. The ridge 302 forms a second width that is greater than the first width. The set of bristles 202 extends from an inferior side 305 of the spine.

In embodiments at least one or more of the couplers 208a, 208b include a first support 306 extending from one side of the coupler 208a and configured to contact the grain header 100 (e.g., at the housing 110a, 110b, the fore portion 106a, 106b, and/or the aft portion 108a, 108b of the row dividers 102a, 102b), and a second support 308 extending from another side of the coupler 208a and configured to contact the front clamp plate 300. In this manner, when a fastener is used (e.g., via the apertures 108) to couple the crop-retaining devices 120a, 120b to the grain header 100 via the couplers 208a, 208b, pressure is placed relatively evenly against the first support 306 and the second support 308 ensuring a secure fit. An interior surface of the top bracket plate 209a and/or an interior surface of the second support 308 may also be configured to contact the ridge 302 upon coupling, increasing the overall security of the connection between the crop-retaining device 120a and the row dividers 102a, 102b.

FIG. 3B illustrates a side view of the crop-retaining device 120a, in accordance with one or more embodiments of the disclosure. The side view shows prominent ridges 302a, 302b that may contact the coupler 208a, 208b and a back clamp plate 310 that, along with the front clamp plate 300, clamps the set of bristles 202. Together, the set of bristles 202, the front clamp plate 300, and the back clamp plate 310 form the first width 312 that is smaller than the width of the spine 204 along the superior side 305 (e.g., a second width 314).

In embodiments, the crop-retaining device 120a includes a second width 314 (e.g., comprising the ridges 302a, 302b) that that is greater than the first width 312 (e.g., formed from the set of bristles 202, the front clamp plate 300, and the back clamp plate 310). The prominent ridges 302a, 302b formed by the differences in widths 312, 314 provide a surface for the couplers 208a, 208b to be secured.

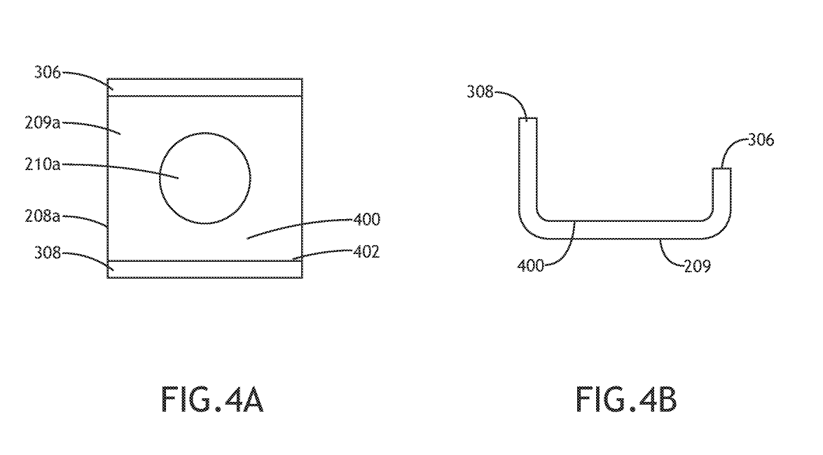

FIG. 4A illustrates an underside view of the coupler 208a, in accordance with one or more embodiments of the disclosure. The underside of the coupler 208a reveals the interior surface 400 of the top bracket plate 209 and the interior surface 402 of the second support 308 that may make contact with one or more ridges 302a, 302b.

FIG. 4B illustrates a side view of the coupler 208a, in accordance with one or more embodiments of the disclosure. In embodiments, a length of the second support 308 is less than a length of the first support 306. For example, the length of the second support 308 may be approximately or substantially half, or less than half, the length of the first support. By adjusting the relative lengths of the first support 306 and the second support 308, pressure placed upon the first support 306 and the second support 308 during coupling is equalized relative to each other, resulting in a more stable and secure coupling.

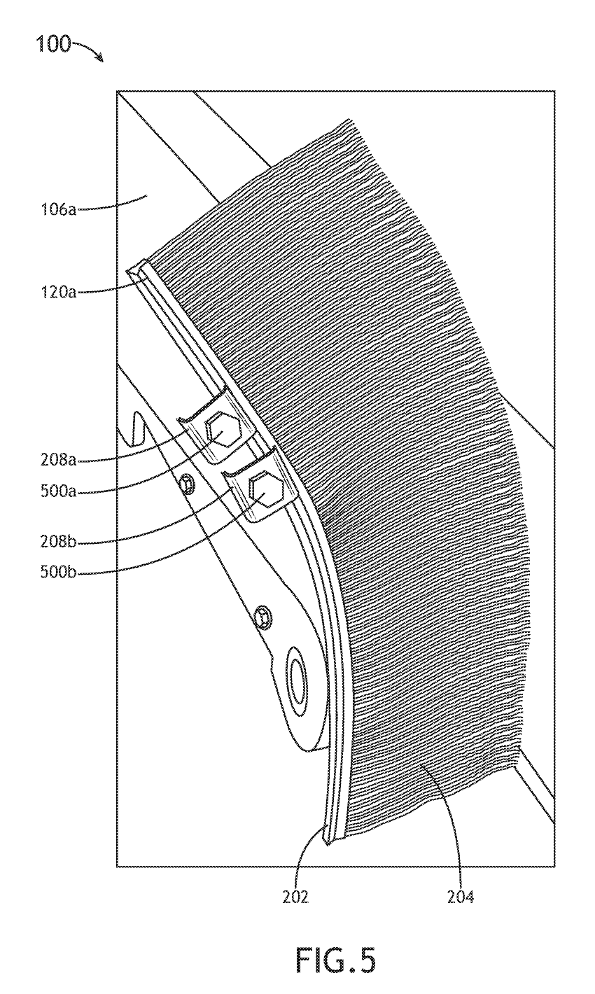

FIG. 5 illustrates a close-up view of a crop-retaining device 120a coupled to a fore portion 106a of the row divider 102a, in accordance with one or more embodiments of the disclosure. The couplers 208 are shown attaching the spine 204 of the crop-retaining device 120a to the fore portion 106a via bolts 500a, 500b (e.g., fasteners). The crop-retaining device 120a may utilize any number of couplers 208 for coupling the crop-retaining device 120a to the row divider 102 including, but not limited to, one coupler 208, two couplers 208, three couplers 28, four couplers 208, five couplers 208, or six of more couplers 208. For example, the crop-retaining device may be coupled to the row divider 102a via two couplers 208. The couplers 208 may be positioned along any length or portion of the spine 204.

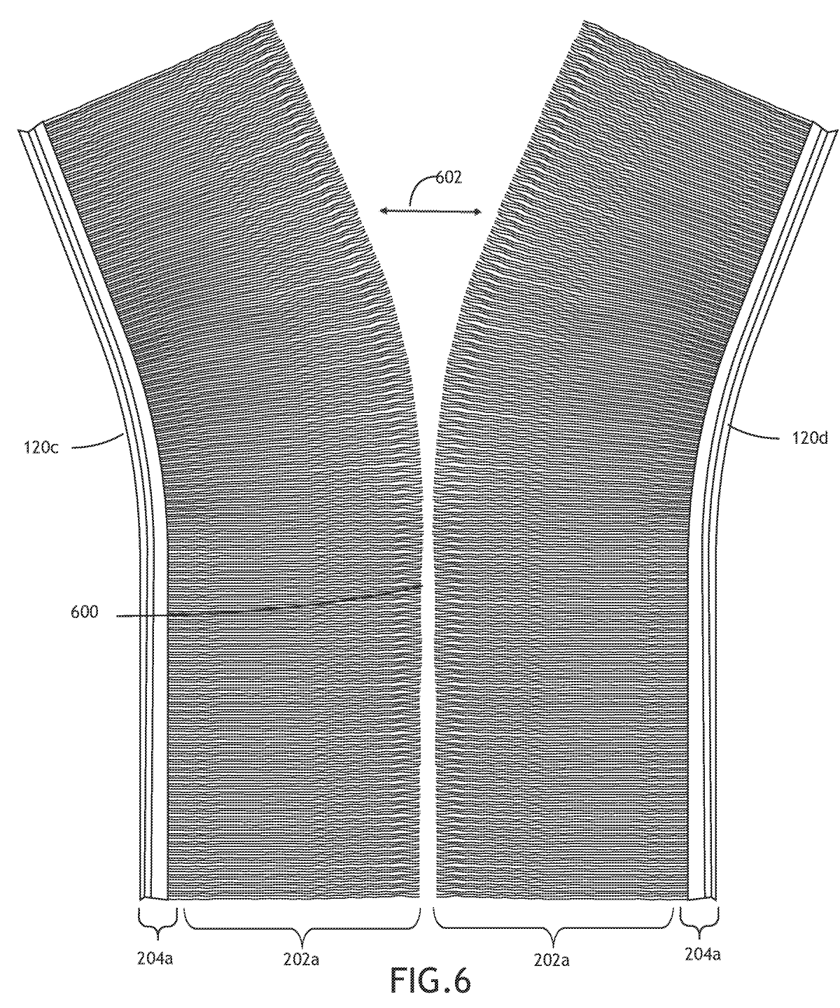

FIG. 6 illustrates a side view of a pair of crop-retaining devices 120a, 120b arranged in a crop-retaining position, in accordance with one or more embodiments of the disclosure. As shown previously in FIG. 1, the spine 204a, 204b of each crop-retaining device 120a, 120b can be attached to the housing 110a, 110b, the fore portion 106a, 106b, and/or the aft portion 108a, 108b of the row dividers 102a, 102b. The pair of crop-retaining devices 120a, 120b may be arranged and/or bent to produce one or more retaining configurations. For example, one or more positions of one or more of the crop-retaining devices 120a, 120b may be positioned and/or bent to produce at least one narrow configuration 600 where the set of bristles 202a, 202b of each crop-retaining devices 120a, 120b are touching or nearly touching. The narrow configuration 600 may be useful for providing strong resistance for ears of corn or other released grains or grain products from passing from the gathering space 104 to the ground 122 (e.g., the second direction). In another example, one or more positions of one or more of the crop-retaining devices 120a, 120b may be positioned and/or bent to produce at least one wide configuration 602 where the set of bristles 202a, 202b of each pair of crop-retaining devices 120a, 120b are relatively far apart. The wide configuration 602 may be useful for blocking ears of corn or other grain products from bouncing out of the grain header 100 and onto the ground 122.

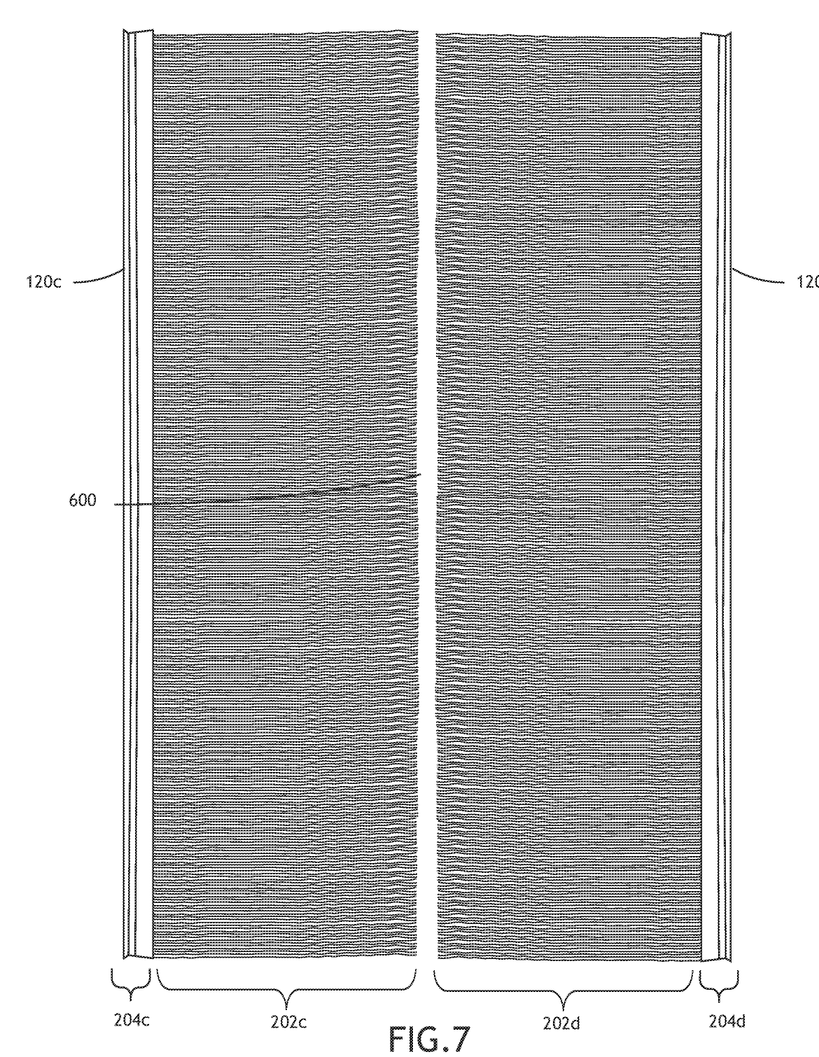

FIG. 7 illustrates a side view of a pair of crop-retaining devices 120c, 120d arranged in a crop-retaining position (e.g., in a narrow configuration 600), in accordance with one or more embodiments of the disclosure. In embodiments, the crop-retaining devices 120c, 120d are initially formed with a straight spine 202c, 202d, and are then bent to provide a custom fit for the grain header 100 and/or a custom configuration (e.g., a narrow configuration 600 and/or wide configuration 602). For instance, the crop-retaining devices 120c, 120d may be initially manufactured and/or sold having a straight spine 202c, 202d, which may then be custom bent by a dealer and/or customer.

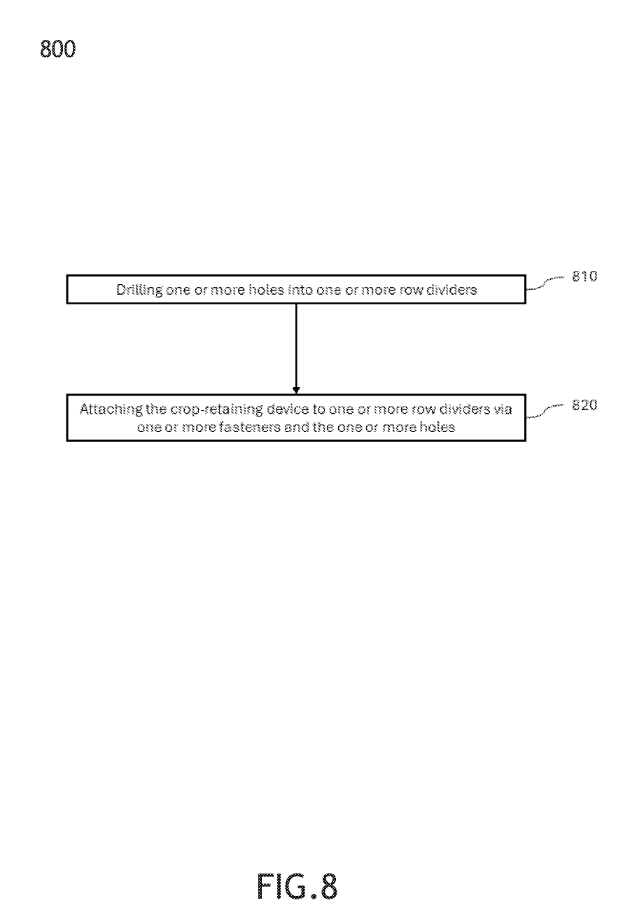

FIG. 8 illustrates a process flow diagram depicting a method 800 for attaching the crop-retaining device 120 to the row dividers 102a, 102b (e.g., the housing 110a, 110b, the fore portion 106a, 106b, and/or the aft portion 108a, 108b of the row dividers 102a, 102b), in accordance with one or more embodiments of the disclosure. The method 800 may be utilized via the crop-retaining device 120 as described in this disclosure.

In embodiments, the method 800 includes a step 810 of drilling one or more holes into one or more row dividers 102a, 102b (e.g., the housing 110a, 110b, the fore portion 106a, 106b, and/or the aft portion 108a, 108b of the row dividers 102a, 102b). In embodiments, the method 800 includes a step 820 of attaching the crop-retaining device 120 to one or more row dividers 102a, 102b via one or more fasteners and the one or more holes (e.g., via the one or more couplers 208a, 208b.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A crop-retaining device comprising:
a brush comprising:
a set of bristles; and
a spine comprising:
a front clamp plate disposed along a front side of the spine;
a back clamp plate disposed along a back side of the spine, wherein the set of bristles are clamped between the front clamp plate and the back clamp plate, wherein the set of bristles extend from an inferior side of the spine, wherein the front clamp plate, the back clamp plate, and the set of bristles clamped between the front clamp plate and the back clamp plate comprise a first width; and
a ridge disposed along a superior side of the spine, wherein the ridge comprises a second width greater than the first width, wherein at least one of the ridge and the front clamp plate are couplable to at least one coupler configured to couple the brush to a grain header.

2. The crop-retaining device of claim 1, further comprising the at least one coupler.

3. The crop-retaining device of claim 2, wherein the at least one coupler comprises:
a bracket comprising:
a top bracket plate comprising at least one aperture and configured to receive at least one fastener;
a first support extending from a first side of the top bracket plate and configured to contact a grain header; and
a second support extending from a second side of the top bracket plate and configured to contact the front clamp plate.

4. The crop-retaining device of claim 3, wherein an interior surface of the top bracket plate is configured to contact the ridge.

5. The crop-retaining device of claim 3, wherein an interior surface of the second support is configured to contact the ridge.

6. The crop-retaining device of claim 3, wherein an interior surface of the top bracket plate and an interior surface of the second support are configured to contact the ridge.

7. The crop-retaining device of claim 1, wherein the spine is configured to flex and retain a flexed position.

8. The crop-retaining device of claim 1, wherein the brush comprises a strip brush.

9. The crop-retaining device of claim 1, wherein the brush comprises a staple set brush.

10. A grain header comprising:
a pair of row dividers; each row divider pair of row dividers comprising a housing;
a pair of gathering chains disposed adjacent to a respective pair of row dividers, each gathering chain of the pair of gathering chains comprising gathering fingers that extend into a gathering space between the pair of row dividers; and
a pair of crop-retaining devices coupled to the respective pair of row dividers and disposed superior to the gathering chains, wherein each of the pair of crop-retaining devices comprise:
a brush comprising:
a set of bristles; and
a spine comprising:
a front clamp plate disposed along a front side of the spine;
a back clamp plate disposed along a back side of the spine, wherein the set of bristles are clamped between the front clamp plate and the back clamp plate, wherein the set of bristles extend from an inferior side of the spine, wherein the front clamp plate, the back clamp plate, and the set of bristles clamped between the front clamp plate and the back clamp plate comprise a first width; and
a ridge disposed along a superior side of the spine, wherein the ridge comprises a second width greater than the first width, wherein at least one of the ridge and the front clamp plate are couplable to at least one coupler configured to couple the brush to the grain header.

11. The grain header of claim 10, further comprising the at least one coupler.

12. The grain header of claim 11, wherein the pair of crop-retaining devices form a selective barrier that allows a grain stalk to pass through in a first direction, but inhibits a separated grain or separated grain unit from passing through in a second direction.

13. The grain header of claim 10, wherein the pair of crop-retaining devices are each coupled to the housing of a respective row divider.

14. The grain header of claim 10, wherein the grain header comprises a corn header, wherein each of the pair of row dividers comprise a fore portion couplable to one or more of the pair of the crop-retaining devices.

15. The grain header of claim 11, wherein the at least one coupler comprises:
a bracket comprising:
a top bracket plate comprising at least one aperture and configured to receive at least one fastener;
a first support extending from a first side of the top bracket plate and configured to contact at least one of a housing, a fore portion, or an aft portion of a row divider; and
a second support extending from a second side of the top bracket plate and configured to contact the front clamp plate.

16. The grain header of claim 15, wherein an interior surface of the top bracket plate is configured to contact the ridge.

17. The grain header of claim 15, wherein an interior surface of the second support plate is configured to contact the ridge.

18. The grain header of claim 15, wherein an interior surface of the top bracket plate and an interior surface of the second support plate are configured to contact the ridge.

19. A harvester comprising:
a grain header comprising:
a pair of row dividers; each row divider pair of row dividers comprising a housing;
a pair of gathering chains disposed adjacent to the respective pair of row dividers, each gathering chain of the pair of gathering chains comprising gathering fingers that extend into a gathering space between the pair of row dividers; and
a pair of crop-retaining devices coupled to a respective pair of row dividers and disposed superior to the gathering chains, wherein each of the pair of crop-retaining devices comprise:
a brush comprising:
a set of bristles; and
a spine comprising:
a front clamp plate disposed along a front side of the spine;
a back clamp plate disposed along a back side of the spine, wherein the set of bristles are clamped between the front clamp plate and the back clamp plate, wherein the set of bristles extend from an inferior side of the spine, wherein the front clamp plate, the back clamp plate, and the set of bristles clamped between the front clamp plate and the back clamp plate comprise a first width; and
a ridge disposed along a superior side of the spine, wherein the ridge comprises a second width greater than the first width, wherein at least one of the ridge and the front clamp plate are couplable to at least one coupler configured to couple the brush to the grain header.

20. The harvester of claim 19, wherein the grain header comprises a corn header.
